(19) United States
(12) Patent Application Publication
(10) Pub. No.: US 2002/0085755 A1
(43) Pub. Date: Jul. 4, 2002

(54) Method for region analysis of document image

(76) Inventors: Su-Young Chi, Taejon (KR); Dae-Geun Jang, Taejon (KR); Young-Sup Hwang, Taejon (KR); Kyung-Ae Moon, Taejon (KR); Su-Hyun Cho, Taejon (KR); Yun-Koo Chung, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/827,210

(22) Filed: Apr. 6, 2001

(30) Foreign Application Priority Data
Dec. 28, 2000 (KR) 2000-83420

(51) Int. Cl. G06K 9/34; G06K 9/68

(52) U.S. Cl. 382/176; 382/226

(57) ABSTRACT

A method for region analysis of a document image applied to region analysis system of a document image, the method includes the steps of: a) analyzing a connected component though a reduced documentimage; b) classifying the connected component by generating a tree according to analysis result of the connected component; c) grouping text components from the classified connected component according to a spatial connection; and d) refining a text block by repeating segmentation and merge of the connected component after the grouping.

### FIELD OF THE INVENTION

The present invention relates to a method for region analysis of a document image; and more particularly, to a method for region analysis of a document image which performs grouping of connected components into a tree according to a spatial relation of the connected components after extracting connected components from the document received through an image input device and arranges a text region by repeating segmentation and merge for the text region, and to a computer readable recording media containing a program for performing the method.

### DESCRIPTION OF THE PRIOR ART

Optical character recognition provides for creating a text file on a computer system from a printed document page. The created text file may then be manipulated by a text editing or word processing application on the computer system. As a document page may be included of both text, pictures and tables, or the text may be in columns, such as in a newspaper or magazine article, document analysis is an important step prior to character recognition. Document analysis is the identification of various text, image (picture), tables and line segment portions of the document image.

However, in general, are search for document structure analysis is relatively less sufficient than that for the character recognition, which has many problems that not the character recognition cannot be applicable to complex documents such as the newspaper or the magazine having multiple columns.

### SUMMARY OF THE INVENTION

It is, therefore, an object of the present invention to provide a method for region analysis of a document image for grouping into a tree according to a spatial connection of the connected components extracted from a reduced document image and for arranging by repeating segmentation and merge for a text region, and a computer readable media containing a program for performing the method.

To achieve the above purpose, in accordance with one aspect of the present invention, there is provided a method for region analysis of a document image applied to region analysis system of a document image, the method comprising the steps of: analyzing a connected component though a reduced document image; classifying the connected component by generating a tree according to analysis result of the connected component; grouping text components from the classified connected component according to a spatial connection; and refining a text block by repeating segmentation and merge of the connected component after the grouping.

In accordance with another aspect of the present invention, there is provided a region analysis system having a processor for analyzing a document image, wherein a computer readable recording media containing a program for implementing the functions of: analyzing a connected component though a reduced document image; classifying the connected component by generating a tree according to analysis result of the connected component; grouping text components from the classified connected component according to a spatial connection; and refining a text block by repeating segmentation and merge of the connected component after the grouping.

### BRIEF DESCRIPTION OF THE DRAWINGS

The above and other objects and features of the present invention will become apparent from the following description of the preferred embodiments given in conjunction with the accompanying drawings, in which:

FIG. 1 describes basic information of a connected component in region analysis of a document image in accordance with the present invention;

FIGS. 2A to 2C depict a type of connected component in region analysis of a document image in accordance with the present invention;

FIG. 3 illustrates a method for calculating a space between the lines and a font size of a character in adjacent word or text in region analysis of a document image in accordance with the present invention;

FIGS. 4A and 4 Bare exemplary of segmentation result of document analyzed in region analysis of a document image in accordance with the present invention;

FIG. 5 shows a tree of page which is generated based on the segmentation result as depicted in FIG. 4B; and

FIG. 6 is a flow chart of region analysis of a document image in accordance with the present invention.

### DETAILED DESCRIPTION OF THE PREFERRED EMBODIMENTS

Hereafter, the present invention will be described in detail with reference to the accompanying drawings.

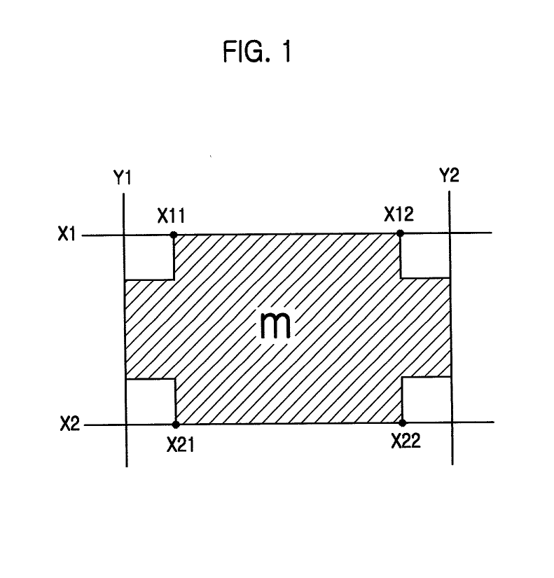

FIG. 1 describes basic information of a connected component in region analysis of a document image in accordance with the present invention.

The document image is inputted to a computer system through an image input device, e.g., a charge coupled devices (CCD) camera or a scanner, and analyzed by a region analysis system, e.g., a computer in accordance with a region analysis method which will be described.

As shown in FIG. 1, in order to generate a set of the merged length such as a connected component for image region (m), wherein a connected component is represented as y1, y2, x1, x2, x11, x12, x21, x22, respectively.

Here, y1 and y2 represent a horizontal expansion of an inscribed square, x1 and x2 represent a vertical expansion of an inscribed square, x11 represents a leftmost point located in x1, x12 represents a rightmost point located in x1, x21 represents a leftmost point located in x2 and x22 represents a rightmost point located in x2, respectively.

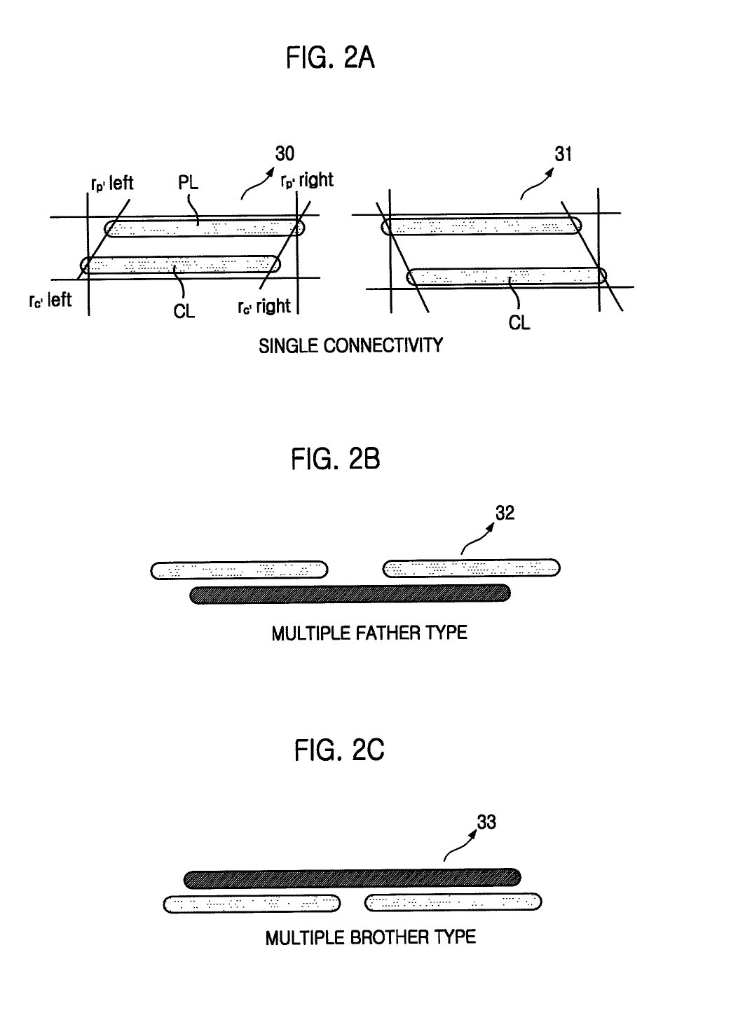

FIGS. 2A to 2C depict a type of connected component in region analysis of a document image in accordance with the present invention.

As shown in FIG. 2A, in case of analyzing a region for document image (m), the upper line between two lines in a document image is defined as a parent line and the lower line is defined as a child line. And, the upper left point of the parent line is defined as rₚleft, the upper right point of the parent line is defined as rₚright, the upper left point of the child line is defined as r_{c}left and the upper right point of the child line is defined as r_{c}right.

As shown in FIG. 2B, a type which has the upper line (patent line) between two lines in a document image where more than two straight lines leave a space and the lower line (child line) locates longer is defined as a multiple father type. As recited in FIG. 2C, a type which has the upper line (patent line) locates longer and the lower line (brother line) where more than two straight lines leave a space is defined as a multiple brother type.

The connected components types defined as above, in case that the reduced document region satisfied the following formula, two lines are connected each other and it ties up to one large connected components region.

In addition, the region according to the multiple parent type and the multiple brother type between two connected components types is performed by the formula as above and is performed until satisfying a condition by repeating continuously the connection between two regions with respect to the result thereof.

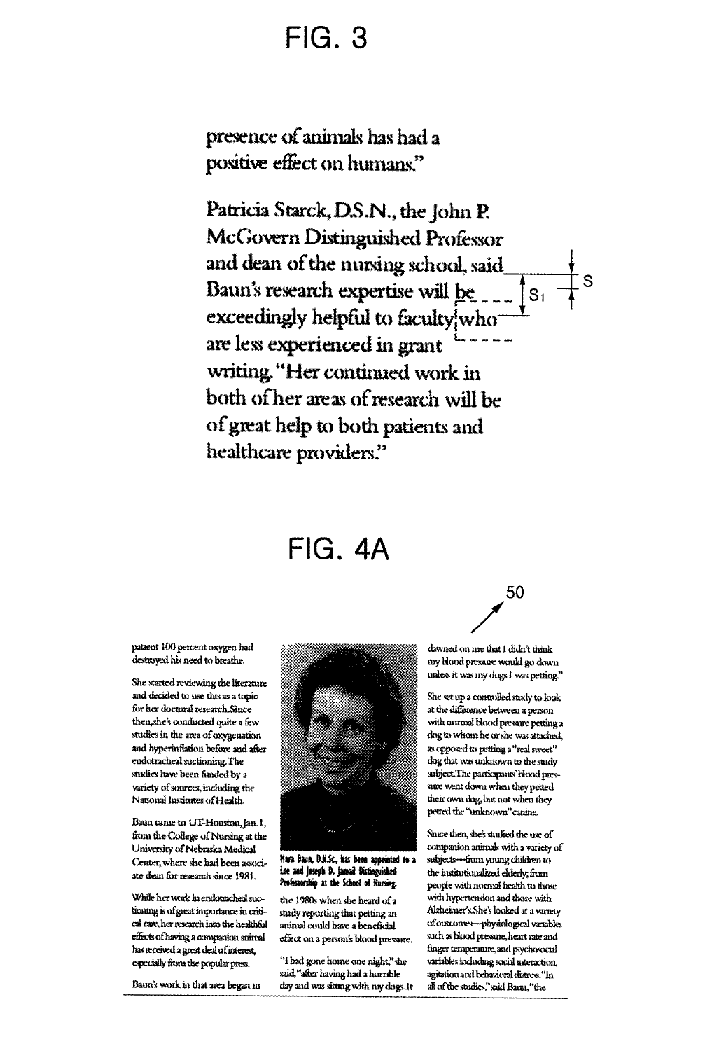

FIG. 3 illustrates a method for calculating a space between the lines and a font size of a character in adjacent word or text in region analysis of a document image in accordance with the present invention.

As shown in FIG. 3, in order to analyze a text which arranged horizontally and vertically and separated irregularly, it calculates the space between the lines and the size of the character in adjacent word or text for each of nodes in replace of the whole document. That is, it searches another component coincided with x-axis direction in regard to the connected component and from the component, the smallest y-axis distance is defined as “S”.

In addition, among several lines in the document image, in case that the present line and the next line do not exist with a regular space and skipping over one line is defined as “S1”.

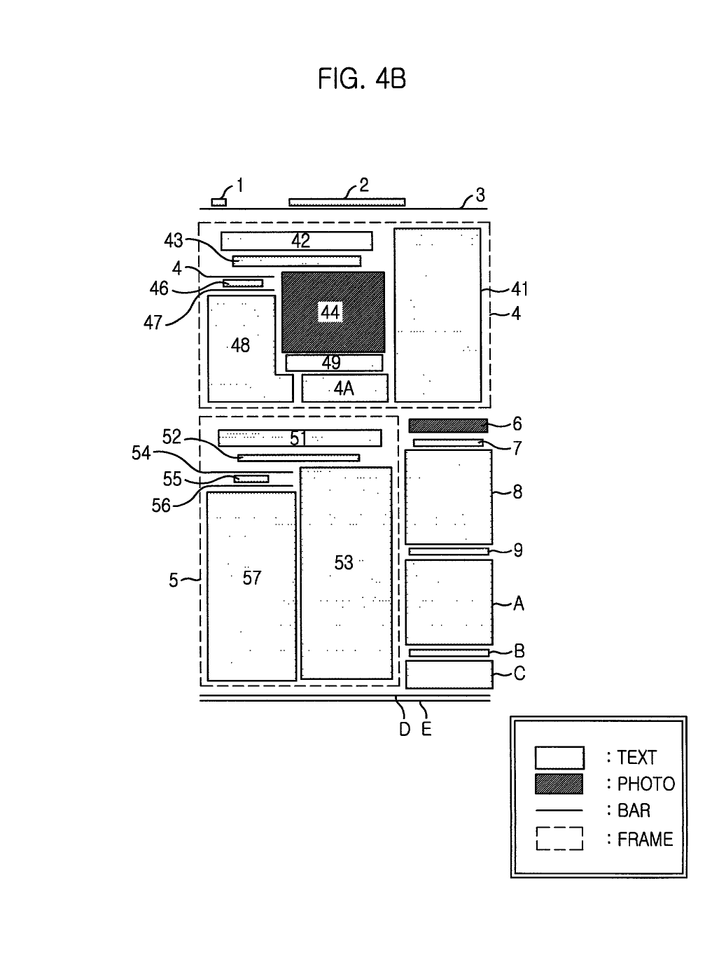

FIGS. 4A and 4B are exemplary of segmentation result of document analyzed in region analysis of a document image in accordance with the present invention.

FIG. 4A shows a document 50 for region analysis containing regions such as text, photo, bar and frame.

Referring to FIG. 4B, the document 50 of FIG. 4A is divided into text, photo, bar and frame region. In the document 50, reference numerals 1, 2, 3, 4, 5, 6, 7, 8, 9 and alphabets A, B, C, D, E represent independent connected components, respectively. Reference numerals 41, 42, 43, 44, 45, 46, 47, 48, 49, 4A denote sub connected components contained in the connected component 4. Reference numerals 51, 52, 53, 54, 55, 56, 57 represent sub connected components contained in the connected component 5.

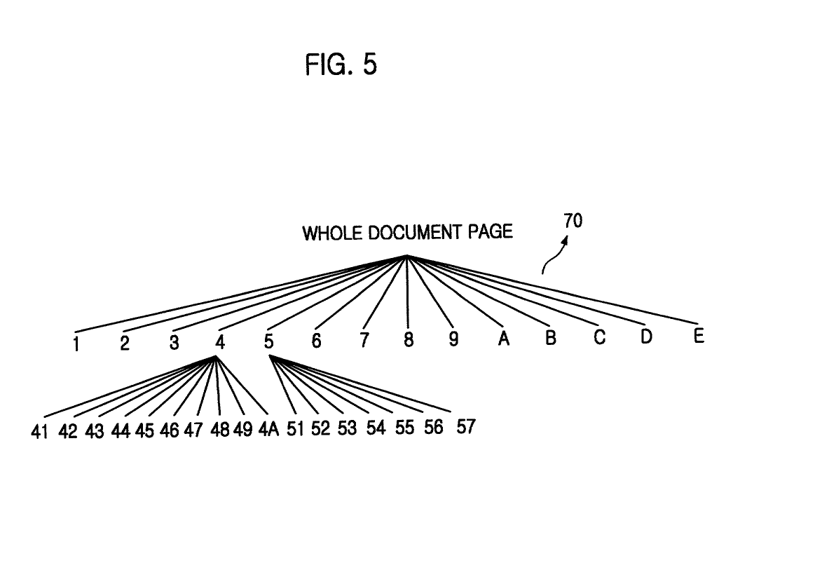

FIG. 5 shows a tree of page which is generated based on the segmentation result as depicted in FIG. 4B.

As shown in FIG. 5, the whole document page 70 is a root and each of internal nodes is defined as a meaning block such as table, text region, photo and bar. Here, the terminal node is the connected component.

First, in the construction of the initial tree from the connected component, the connected components having table, frame and photo are grouping into an independent node with the text pertaining to the components and the connected components in a text block surrounded by a space are clustered in a next step.

Next, in classifying the nodes roughly, the connected component which has a high height and a narrow width is referred as “vertical bar” and that which has a long height and large dimension is referred as “vertical picture”. Similarly, it is classified into “horizontal bar” and “horizontal picture”. In case that the width and length of the connected component are larger than those of the largest character, it is non-text region and is referred as table, frame or picture. The other components are referred as text as far as possible.

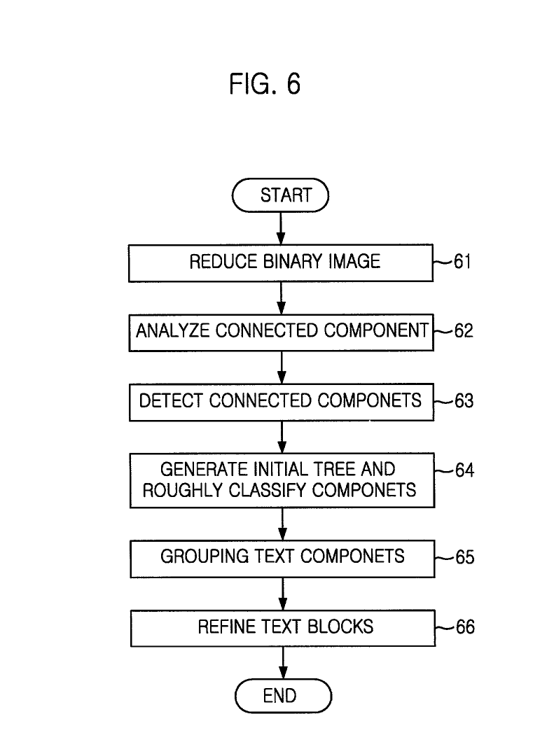

FIG. 6 is a flow chart of region analysis of a document image in accordance with the present invention.

As shown in FIG. 6, first, to reduce an image before analyzing the connected component is for reducing a processing time of system by decreasing a number of components 61. Then, based on the reduced image, it searches the reduced image by one line and merges 8-connected runs. At this time, it analyzes the connected component and defines the corresponding types 62 and 63.

Here, the analysis of the connected component is analyzed by the formula as above. In case that each line is analyzed and the line is satisfied the formula, it is recognized that two lines are connected to each other, and tied up into one large connected component region. Consequently, comparing with next line, finally, the type of connected component is defined by analyzing the connected components again and again.

Then, to generate the initial tree based on the connected component types defined as above, that is, in generating the initial tree from the connected components, the connected components having such as table, frame and photo are used to grouping into an independent node with a text pertaining to the components. And then, the connected components in the text block surrounded by a space are clustered in the next step and it classifies the components through the segmentation of the nodes 64. Grouping the text components is to process the complex documents having the text separated irregularly and arranged horizontally and vertically. In order for this process, in advance, it calculates an average distance between two lines in adjacent text and then, a distance between two lines from all of components. Thereafter, it is possible to group the text components by removing a large value which is not coincided with space between adjacent lines.

At this time, the grouping is that depends on the distance between two components. In case that the distance of two optional components is close to each other, it becomes grouping into one block. And the regulation of basic information is used to decide whether the component is near. In case that a vertical distance of a square surrounded by the component is smaller than that of between adjacent lines and characters, and it coincides with x-axis direction of two squares, the distance between the two is close to each other. Then, in case that it is close to the optional connected component of the block, one connected component ties up it into one block.

At this time, if a component is not adjacent to optional component, it designates a new block. Here, since the block is formed, it reconstructs the text block by calculating an arranging line of text, a space between the characters and the size of the character.

As described as above, the method of the present invention can be stored in computer readable medias, e.g., a CD-ROM, a RAM, a ROM, a floppy disk, a hard disk, and a photomagnetic disk, etc., containing a program.

As disclosed above, the present invention has an effect to extract connected components by the existed criteria, to group into the tree according to a spatial connection of the connected components extracted and to perform efficiently the analysis of the document structure by repeating segmentation and merge in the text region.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A method for region analysis of a document image inputted through an image input device, which is applied to a region analysis system, the method comprising the steps of:
a) analyzing connected components though a reduced document image;
b) classifying the connected components by generating a tree according to analysis result of the connected components;
c) grouping text components in the classified connected components according to a spatial connection, thereby generating a text block; and
d) refining the text block by repeating segmentation and merge of the connected component after the grouping.

2. The method as recited in claim 1, wherein the step a) includes the step of:
if bigger one between r_{c}left local coordinate and rₚleft local coordinate in the document image is smaller than or equal to smaller one between r_{c}right local coordinate and rₚright local coordinate in the document image, collecting two lines into one region and analyzing the lines,
wherein rₚleft is a upper left point of a parent line, rₚright is a upper right point of the parent line, r_{c}left is a upper left point of a child line and r_{c}right is a upper right point of the child line.

3. The method as recited in claim 1, wherein the connected components are classified into types of single line, multiple patent line and multiple brother line.

4. The method as recited in claim 1, wherein the step b) includes the steps of:
b1) constructing a tree based on types of the connected components;
b2) grouping the connected components containing a table, a frame or a picture in the tree and the text in the connected components and generating an independent node;
b3) grouping the connected components in the text block surrounded by space; and
b4) classifying the nodes which are not grouped, based on a region of each the connected component.

5. The method as recited in claim 1, wherein grouping of the text component in the step c) is performed in text components having the same parent node and grouping of horizontally/vertically arranged text is performed by calculating spaces between the lines and font sizes of characters in adjacent word or text for each of internal node in replace of the whole documents.

6. The method as recited in claim 3, wherein the step b4) includes the steps of:
classifying the connected component having a high height and a narrow width as a vertical bar;
classifying the connected component of a high height and a wide width are larger than those of a picture located vertically and a biggest character as a non-text region.

7. In a region analysis system having a processor for analyzing a document image, a computer readable recording media containing a program for implementing the functions of:
a) analyzing a connected component though a reduced document image;
b) classifying the connected component by generating a tree according to analysis result or the connected component;
c) grouping text components from the classified connected component according to a spatial connection; and
d) refining a text block by repeating segmentation and merge of the connected component after the grouping.
